(19) United States
(12) Patent Application Publication
(10) Pub. No.: US 2025/0010204 A1
(43) Pub. Date: Jan. 9, 2025

(54) GAME SYSTEM AND NON-TRANSITORY COMPUTER-READABLE MEDIUM INCLUDING VIDEO GAME PROCESSING PROGRAM

(71) Applicant: SQUARE ENIX CO., LTD., Tokyo (JP)

(72) Inventor: Yu WATANABE, Tokyo (JP)

(73) Assignee: SQUARE ENIX CO., LTD., Tokyo (JP)

(21) Appl. No.: 18/740,357

(22) Filed: Jun. 11, 2024

(30) Foreign Application Priority Data
Jul. 7, 2023 (JP) 2023-111842

(51) Int. Cl. A63F 13/77; A63F 13/35

(52) U.S. Cl. CPC A63F 13/77; A63F 13/35

(57) ABSTRACT

One or more embodiments of the disclosure provide a game system including: a terminal device configured to execute a video game including content used in the video game; and a server device connected to the terminal device via a communication network and configured to control progress of the video game. The game system further includes a processor configured to: issue a non-fungible token (NFT) corresponding to the content in a blockchain network with a user as an owner within a range of an upper limit number; acquire information for specifying a remaining number of NFTs corresponding to the same type of content in the blockchain network; and change at least a part of a status associated with the content according to the remaining number.

### CROSS-REFERENCE TO RELATED APPLICATION

The present application claims priority to and the benefit of Japanese Patent Application No. 2023-111842 filed on Jul. 7, 2023, the disclosure of which is expressly incorporated herein by reference in its entirety for any purpose.

### BACKGROUND

At least one embodiment of the disclosure relates to a game system and a non-transitory computer-readable medium including a video game processing program.

In recent years, an NFT game (blockchain game) using a blockchain technology has begun to be provided (see, for example, “CRYPTO SPELLS”, [online], CryptoGames, [searched on Jun. 6, 2023], Internet <URL: https://cryptospells.jp/>). In the NFT game, for example, a non-fungible token (an NFT) of a content such as a character or an item used in the game is issued. An upper limit of the number of issued NFTs such as characters is sometimes defined, and trade transactions between users in marketplace and the like are also actively performed. In addition, the NFT such as a character is deleted by being burned (incinered) for reasons such as becoming unnecessary thereafter. Therefore, the number of remaining NFTs of a character or the like fluctuates with time.

### SUMMARY

In the above-described NFT game, it is an object to improve the interest of a game using an NFT such as a character while considering the characteristics of the NFT as described above.

It is an object of at least one embodiment of the disclosure to solve the deficiencies of the related art.

From a non-limiting viewpoint, a game system according to an embodiment of the disclosure includes a terminal device that executes a video game including content used in a game, and a server device that is connected to the terminal device via a communication network and controls progress of the video game. The game system includes an issuer for issuing a non-fungible token (hereinafter referred to as NFT) corresponding to the content in a blockchain network with the user as an owner within a range of the upper limit number, an acquirer for acquiring information for specifying the remaining number of NFTs corresponding to the same type of content in the blockchain network, and a setter for changing at least a part of a status associated with the content according to the remaining number.

From a non-limiting viewpoint, a non-transitory computer-readable medium according to the embodiment of the disclosure includes a video game processing program that, when executed, causes a computer that controls progress of a video game including content used in a game, to execute: an issuing function for issuing a non-fungible token (hereinafter, referred to as NFT) corresponding to the content in a blockchain network with the user as an owner within a range of the upper limit number, an acquisition function for acquiring information for identifying the remaining number of NFTs corresponding to the same type of content in the blockchain network, and a setting function for changing at least a part of a game status associated with the content according to the remaining number.

From a non-limiting viewpoint, a non-transitory computer-readable medium according to the embodiment of the disclosure includes a video game processing program that, when executed, causes a server device that is connected to a game terminal device via a communication network and controls progress of a video game, the game terminal device executing the video game including content used in the game, to execute: an issuing function for issuing a non-fungible token (hereinafter, referred to as NFT) corresponding to the content in a blockchain network with the user as an owner within a range of the upper limit number, an acquisition function for acquiring information for identifying the remaining number of NFTs corresponding to the same type of content in the blockchain network, and a setting function for changing at least a part of a status associated with the content according to the remaining number.

One or more deficiencies are solved by embodiments of the present application.

### BRIEF DESCRIPTION OF THE DRAWINGS

FIG. 1 is a block diagram showing an example of a configuration of a game system corresponding to at least one embodiment of the disclosure.

FIG. 2 is a block diagram showing a configuration of a server device corresponding to at least one embodiment of the disclosure.

FIG. 3 is a flowchart showing an example of issuance processing corresponding to at least one embodiment of the disclosure.

FIG. 4 is a flowchart showing an example of setting processing corresponding to at least one embodiment of the disclosure.

FIG. 5 is a block diagram showing a configuration of a server device corresponding to at least one embodiment of the disclosure.

FIG. 6 is a flowchart showing an example of issuance processing corresponding to at least one embodiment of the disclosure.

FIG. 7 is a flowchart showing an example of setting processing corresponding to at least one embodiment of the disclosure.

FIGS. 8A and 8B are schematic views each showing an example of an NFT sticker corresponding to at least one embodiment of the disclosure.

FIGS. 9A, 9B, 9C, 9D, and 9E are schematic diagrams each showing an example of a status change of the NFT sticker corresponding to at least one embodiment of the disclosure.

FIG. 10 is a diagram showing an example of sticker data corresponding to at least one embodiment of the disclosure.

FIG. 11 is a block diagram showing a configuration of a server device corresponding to at least one embodiment of the disclosure.

FIG. 12 is a diagram showing an example of user data corresponding to at least one embodiment of the disclosure.

FIG. 13 is a flowchart showing an example of issuance processing corresponding to at least one embodiment of the disclosure.

FIG. 14 is a flowchart showing an example of setting processing corresponding to at least one embodiment of the disclosure.

FIG. 15 is a flowchart showing an example of burn processing corresponding to at least one embodiment of the disclosure.

### DETAILED DESCRIPTION

Hereinafter, an example of an embodiment of the disclosure will be described with reference to the drawings. Various constituent elements in the examples of the embodiments described below can be appropriately combined within a range in which no contradiction or the like occurs. Further, description of the content described as an example of a certain embodiment may be omitted in other embodiments. Further, the contents of operations and processes not related to the characteristic portions of the embodiments may be omitted. Further, the order of various processes constituting various flows described below is not the same as long as no contradiction occurs in the contents of the processes.

### First Embodiment

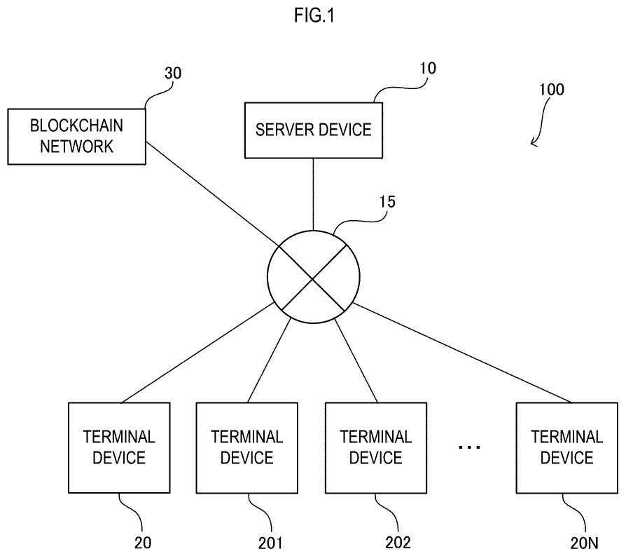

FIG. 1 is a block diagram showing an example of a configuration of a game system 100 according to an embodiment of the disclosure. As shown in FIG. 1, a game system (system) 100 includes a server device 10 and terminal devices 20, 201 to 20N (N is an arbitrary integer) used by a plurality of users (players) who play a video game (game). The server device 10 and the plurality of terminal devices 20 and 201 to 20N are connected to a communication network 15 such as the Internet. Note that the configuration of the system 100 is not limited thereto, and for example, a configuration including a plurality of server devices may be employed. Alternatively, a virtual server device may be configured using cloud computing.

The system 100 also includes a blockchain network 30. The blockchain network 30 is a distributed database network including a plurality of nodes (computers). In the blockchain network 30, a unit of data called a block is generated and connected like a chain to store a blockchain (distributed ledger). In the blockchain network 30, transactions such as a fungible token and a non-fungible token (NFT) are possible. Examples of the blockchain network 30 include an existing platform such as Ethereum. The blockchain network 30 is also an NFT marketplace capable of generating (issuing) and trading (secondary distribution) NFTs. Since the blockchain technology including the issuance of the NFT, the trade transaction, and the like has a general configuration, a detailed description thereof will be omitted.

The system 100 has various functions for executing a game including content used in the game. In the game of the example of the present embodiment, an NFT corresponding to the content is issued with the user as an owner. Further, at least a part of the game status associated with the content is changed in accordance with the remaining number of NFTs corresponding to the content of the same type.

The content is digital content, and is a creative object such as a character or an item used in a game. For example, a virtual object such as a character that assists the progress of the game of the user, a character that is an enemy of the user, or an item in which a specific effect is generated by use corresponds to the content. Further, for example, a sticker-like virtual object including an image of a character corresponds to the content. The user can acquire the NFT corresponding to the content by, for example, consuming and purchasing (primary distribution) legal currency, virtual currency, or the like. That is, the NFT corresponding to the content is issued with the user who is the purchaser as the owner.

In the example of the present embodiment, the upper limit number of NFT issuances is set for each type of content. That is, the NFT corresponding to the same type of content has an upper limit number of NFTs to be issued, and the NFT is not issued beyond the upper limit number of NFTs.

The remaining number of NFTs corresponding to the same type of content is the current number of NFTs that exist effectively in the blockchain network 30. The effectively existing NFT is an NFT that can be used in a trade transaction or the like in the blockchain network 30. Therefore, the burned NFT does not correspond to a valid NFT. The remaining number of NFTs corresponding to the same type of content is counted by an NFT issued with the user as an owner. That is, the remaining number of NFTs corresponding to the same type of content is the remaining number of NFTs after primary distribution.

The primary distribution means that the NFT corresponding to the content is handed over to the user without going through another user (in a new state). The secondary distribution means that the NFT that has once entered the market (which has been handed over to another user) is sold to another user again. The NFT corresponding to the content is deleted by burning. Therefore, the remaining number varies. Specifically, after the NFTs corresponding to the same type of content are issued up to the upper limit number, the NFTs are basically not newly issued, and the remaining number decreases due to the burn.

The type of content is classified by information forming the content, such as a name, a status, and an image. Therefore, in the case of contents having the same names, statuses, images, and the like, they are of the same type. For example, contents having the same name but different statuses are not of the same type. For example, the same identification information is associated with the same type of content.

The game status associated with the content is data referred to in the progress of the game. For example, parameters (numerical values) such as vitality (HP), attack power (ATK), and defense power (DEF) are included in the status. For example, as the number of remaining NFTs of a certain type of content decreases, the attack power of the certain type of content is changed to increase.

In addition, for example, an in-game event that can be executed is also included in the status. The in-game event means an event occurring in the game space. For example, when the sticker-like virtual object including the image of the character is content, causing the character to perform a predetermined action corresponds to an in-game event. The predetermined action is, for example, an attack action on an enemy character such as a magic. In addition, for example, an event in which the weather in the game space is changed or the in-game time is changed (changed from daytime to nighttime), instead of the action to be performed by the character as described above, corresponds to the in-game event of the example of the present embodiment.

For example, when the ratio (remaining number/issued number) of the remaining number of NFTs of a certain type of content becomes equal to or less than a predetermined value, a predetermined event is newly added to an in-game event capable of executing a certain type of content.

Changes in status as in the examples described above will affect the play of the user's game. Specifically, when the content of the changed status is used in the game, the user can more advantageously proceed with the game.

The server device 10 is managed by an administrator of the system 100, and has various functions for providing information on the progress of the game to the user terminals 20 and 201 to 20N. The server device 10 provides, for example, information (image generation information) for generating a game image related to issuance of an NFT, status change, and the like. The server device 10 is configured by an information processing device such as a WWW server to provide information related to control of the progress of the game, and includes one or more storage media (storage units) that store various kinds of information. The server device 10 also includes a control unit including a CPU and the like. Since the above-described configuration is a general configuration, a detailed description thereof will be omitted.

The storage unit may have a configuration built in the server device 10 or a configuration of a storage device such as a database device separate from the server device 10. Alternatively, as the blockchain, a configuration in which a blockchain network is used as a storage unit may be employed.

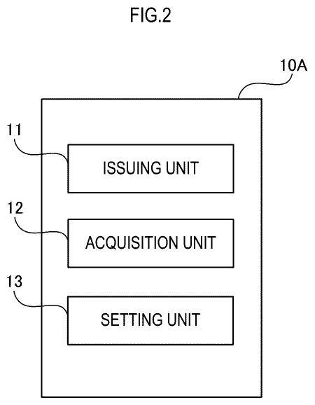

FIG. 2 is a functional block diagram illustrating a configuration of a server device 10A which is an example of a configuration of the server device 10. The server device 10A includes at least an issuing unit 11, an acquisition unit 12, and a setting unit 13 when the control unit executes software (a video game processing program) for controlling the progress of the game stored in the storage unit. The video game processing program also includes game data.

The issuing unit (issuing function, issuing means, issuing process) 11 issues the NFT corresponding to the content with the user as the owner within the range of the upper limit number. The issuance of the NFT is to record the location of the ownership of the content in the blockchain. That is, a token ID (NFT_ID) is issued to the content, and a blockchain in which metadata such as information specifying the content of the game and information specifying the owner, a transaction history, and the like are associated with the token ID is generated.

For example, the issuing unit 11 issues an NFT corresponding to the content to the blockchain network 30 by making an issuance request. For example, the issuing unit 11 receives a purchase request for the content (NFT) from the user (the terminal devices 20 and 201 to 20N). Thus, the issuing unit 11 performs payment processing (billing processing) with legal currency, virtual currency, or the like possessed by the user. After completion of the billing process, the issuing unit 11 transmits an NFT issuance request corresponding to the purchased content to the blockchain network 30. Since the billing process has a general configuration, a detailed description thereof will be omitted.

For example, the issuing unit 11 transmits (uploads) information specifying the content of the game, information specifying the owner, and the like to the blockchain network 30 together with the NFT issuance request. As a result, the NFT corresponding to the content is issued in the blockchain network 30. Then, the issuing unit 11 sends the NFT corresponding to the content to the wallet (terminal device) of the purchaser (user).

The information specifying the content of the game includes, for example, the identification information of the game and the identification information of the content in the example of the present embodiment. The information specifying the owner is identification information (user ID) of the user who purchases (obtains) the content (NFT). The user ID may be, for example, a wallet address of the user (terminal device). The user ID may be stored in the storage unit of the server device 10A in association with the identification information (game user ID) for the game of the user, for example.

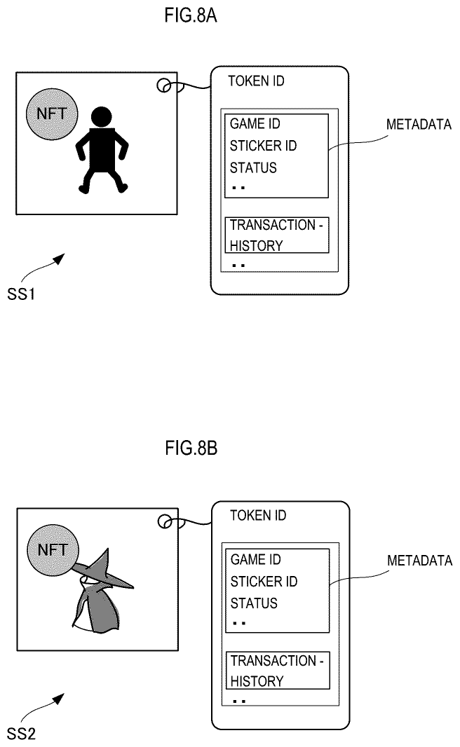

Metadata and transaction history are also recorded in the blockchain of the NFT corresponding to the content (see FIGS. 8A and 8B, for example). The metadata includes, for example, information specifying the content of the game and information specifying the owner. The transaction history is a history of secondary distribution of ownership of the content, and includes identification information (user ID) of the assignee and the assignee of the content.

In addition, the issuing unit 11 does not accept the issuance of the NFT of the content of which the issuance number has reached the upper limit number. The upper limit number is set for each type of content.

The information (including the upper limit number) relating to the content (NFT) to be sold may be stored in the storage unit of the server device 10A. When a plurality of types of contents (NFT) are sold, an image of a list of sales contents may be displayed on a terminal device of a user, and the user may select contents to be purchased.

The acquisition unit (acquisition function, acquisition means, acquisition processing) 12 acquires information for specifying the remaining number of NFTs corresponding to the same type of content in the blockchain network 30. The information for specifying the remaining number corresponds to, for example, the number of issuances and the number of burns with respect to the NFT corresponding to the same type of content. The number of NFTs issued corresponding to the same type of content is the total number of NFTs issued so far. The number of NFTs corresponding to the same type of content is the total number of NFTs burned up to now. A value obtained by subtracting the number of burns from the number of issuances is the remaining number.

For example, the acquisition unit 12 may acquire the number of issuances and the number of burns from the storage unit of the server device 10A. In this case, for example, the issuance number may be updated by the issuing unit 11. Specifically, when receiving the information on the completion of the issuance of the NFT corresponding to the content from the blockchain network 30, the issuing unit 11 adds 1 to the number of issuances of the NFT corresponding to the content. That is, the issuing unit 11 updates the number of NFTs issued corresponding to the content for each of the same types.

Further, for example, the number of burns may be updated by the server device 10A functioning as a burn unit. The burner burns the designated NFT based on a request from the user. Specifically, when receiving the information of the burn completion of the NFT corresponding to the content from the blockchain network 30, the burn unit adds 1 to the number of burns of the NFT corresponding to the content. That is, the burn unit updates the number of burns of the NFT corresponding to the content for each of the same types.

The above-described example is effective when the issuance of the NFT and the burn are executed via the server device 10A. In addition, for example, the acquisition unit 12 may calculate the remaining number for each type after acquiring the number of issued NFTs and the number of burns corresponding to the content for each type.

The information for specifying the remaining number may be, for example, the remaining number itself. In this case, the acquisition unit 12 may request the blockchain network 30 to transmit the remaining number of NFTs corresponding to each type of content. Specifically, the acquisition unit 12 requests the blockchain network 30 to transmit the identification information of the game and the identification information of the content. As a result, the remaining number of NFTs corresponding to each type of content is transmitted from the blockchain network 30 to the server device 10A.

The setting unit (setting function, setting means, setting process) 13 changes at least a part of the game status associated with the content according to the remaining number of NFTs of the content of the same type. For example, as described above, as the number of remaining NFTs of a certain type of content decreases, the attack power of the certain type of content is changed to increase. All the statuses for the game of the content may be stored in the storage unit of the server device 10A. Therefore, the setting unit 13 may change (update) the status stored in the storage unit of the server device 10A, for example. The change by the setting unit 13 is reflected to all users who can use the NFT corresponding to the content to be changed. For example, it is the owner of the NFT corresponding to the content to be changed.

The setting unit 13 may specify the remaining number by referring to the information on the remaining number acquired by the acquisition unit 12. When the acquisition unit 12 calculates the remaining number or when the acquisition unit 12 acquires the remaining number, the remaining number may be referred to.

For example, the setting unit 13 may change the NFT of the content satisfying the change condition. For example, as described above, the change condition may be that the ratio (remaining number/number of issuances) is equal to or less than a predetermined value. Specifically, when the ratio (remaining number/issued number) of the remaining number of NFTs of a certain type of content becomes equal to or less than a predetermined value, a predetermined event is newly added to an in-game event capable of executing a certain type of content.

The setting unit 13 may perform the change with reference to the change content including the change condition and the like. The content of the change may be stored in the storage unit of the server device 10A, for example. In addition, the change content may be common to all types of content, or may be different for each type of content. In the case where the change content is different for each type of content, the change content may be stored in association with the identification information of the content.

Next, the terminal devices 20 and 201 to 20N will be described. Each of the plurality of terminal devices 20 and 201 to 20N is managed by a user who plays a game, and is configured by, for example, a communicable terminal device such as a stationary game device, a personal computer, a mobile phone terminal, PDA (Personal Digital Assistants), or a portable game device.

Each of the terminal devices 20 and 201 to 20N includes an operation device (operation unit), a storage medium (storage unit), a control unit including a CPU and the like, a display unit, an audio output unit (speaker and the like), a communication control unit, and the like. Since the above-described configuration is a general configuration, a detailed description thereof will be omitted. Software (application program) or the like for executing a game by communicating with the server device 10 is stored in the storage units of the terminal devices 20 and 201 to 20N.

For example, the terminal devices 20 and 201 to 20N generate game images based on the image generation information received from the server device 10. The terminal devices 20 and 201 to 20N transmit, for example, various requests input by the user using the operation unit to the server device 10.

The terminal devices 20 and 201 to 20N may function as wallets, for example. A wallet is a means for managing tokens. An application program for executing the wallet may be stored in the storage units of the terminal devices 20 and 201 to 20N. The NFT corresponding to the content is stored (stored) in the wallet of the acquired user. In this case, the wallet information (e.g., wallet address) may be stored as user data in the server device 10 (storage unit) in association with the game user ID, for example.

In addition, the terminal devices 20 and 201 to 20N can also buy and sell (secondary distribution) the NFTs stored in the wallet in the blockchain network 30.

Next, the operation of the system 100 will be described.

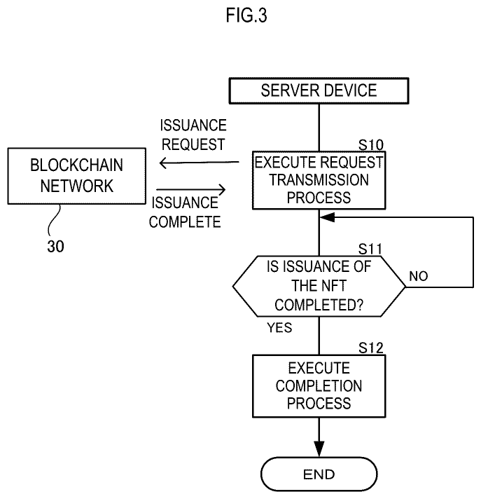

FIG. 3 is a flowchart illustrating an example of issuance processing executed by the system 100. The issuing process in the example of the present embodiment is a process for issuing an NFT corresponding to a content in the blockchain network 30. In FIG. 3, the process of issuing the NFT of the content purchased by the user is mainly described, and the other processes may be partially omitted. Hereinafter, a case where the NFT of the content purchased by the user (terminal device 20) is issued will be described as an example.

The issuing process of the example of the present embodiment is started, for example, when the payment process (billing process) of the content desired to be purchased selected by the user (terminal device 20) is completed. As described above, the billing process is executed when a purchase request for the selected content is received from the user (terminal device 20). The user may select the content desired to be purchased from the image of the list of the NFT-issuable content displayed on the terminal device 20.

The server device 10A executes a request transmission process (step S10). In the request transmission process, an NFT issuance request corresponding to the purchased content is transmitted from the server device 10A to the blockchain network 30. For example, the server device 10A transmits information for specifying the content of the game, information for specifying the owner, and the like to the blockchain network 30 together with the NFT issuance request.

Next, the server device 10A determines whether or not the issuance of the NFT is completed (step S11). The server device 10A waits until the issuance of the NFT is completed. When receiving the information indicating that the issuance of the NFT has been completed from the blockchain network 30, the server device 10A determines that the issuance of the NFT has been completed.

When the issuance of the NFT is completed (step S11: YES), the server device 10A executes a completion process (step S12). In the completion process, the server device 10A sends the NFT corresponding to the content to the wallet (terminal device 20) of the purchaser (user). In addition, the server device 10A may add 1 to the number of NFTs issued corresponding to the content, for example. The number of issuances may be stored in the storage unit of the server device 10A. Further, the server device 10A may transmit, for example, completion of issuance of the NFT to the user (the terminal device 20). Thereafter, the server device 10A ends the issuance process.

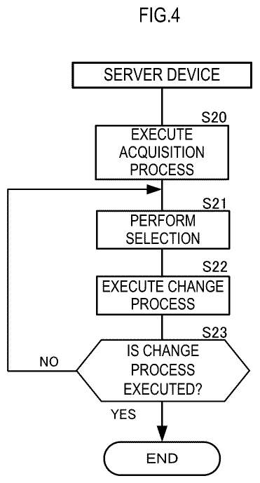

FIG. 4 is a flowchart illustrating an example of setting processing executed by the system 100. The setting processing in the example of the present embodiment is processing for changing at least a part of the status of the content. In FIG. 4, the process of acquiring the above-described information for specifying the remaining number and the process of changing at least a part of the status are mainly described, and other processes may be partially omitted.

The setting process of the example of the present embodiment is repeatedly executed, for example, every time a predetermined period elapses (for example, in units of one frame). The server device 10A executes an acquisition process (step S20). In the acquisition process, the information for specifying the remaining number is acquired. For example, as information for specifying the remaining number, the number of issuances and the number of burns are acquired from the storage unit of the server device 10A. In the acquisition processing, for example, the number of issued NFTs and the number of burns corresponding to the content for each type are acquired, and the remaining number for each type is calculated. Instead of the acquisition process, a transmission request may be made to the blockchain network 30 to acquire the remaining number of NFTs of each type of content.

Next, the server device 10A selects an NFT corresponding to one type of content (step S21), and executes a change process (step S22). In the change process, at least a part of the status of the one type of content is changed. As in the example described above, as the number of remaining NFTs of the one type of content decreases, the attack power of the one type of content is changed to increase. Alternatively, for example, when the ratio (remaining number/issued number) of the remaining number of NFTs of the one type of content becomes equal to or less than a predetermined ratio (change condition is satisfied), a predetermined event is newly added to the in-game event capable of executing the one type of content. When the change condition is not satisfied, the change of the status is not executed, and the change process is ended.

Next, the server device 10A determines whether or not the change processing has been executed for the NFTs corresponding to all types of contents (step S23). When the process is not executed (step S23: NO), the server device 10A returns to the process of step S21. Thereafter, an NFT corresponding to another type of content is selected, and the same processing as described above is executed. On the other hand, when the change processing is executed for the NFTs corresponding to all types of contents (step S23: YES), the server device 10A ends the setting processing.

In the change process, when the user plays a game using the content (NFT) in which at least a part of the status is changed, the change is reflected.

As described above, as one aspect of the first embodiment, since the server device 10A is configured to include the issuing unit 11, the acquisition unit 12, and the setting unit 13, a change in the number of remaining NFTs corresponding to the same type of content (characteristics of the NFTs) is associated with the play of the game. Accordingly, it is possible to improve the interest of the game using the NFT.

Note that the video game of the example of the above-described embodiment can adopt games of various genres as long as content such as characters is used.

Although a predetermined value is set as the upper limit number in the example of the above-described embodiment, the upper limit number is not particularly limited thereto. For example, the number of issuances when the NFT is issued with a limited period also corresponds to the upper limit number. Specifically, the NFT corresponding to a certain type of content is released (issued) unlimitedly only for one month of the sales period. After the sales period has elapsed, this NFT is not issued. In this case, the number of issued NFTs corresponding to a certain type of content during the sales period corresponds to the upper limit number.

In the example of the above-described embodiment, the upper limit number is provided for the issuance of the NFT, but the upper limit number may not be provided. Even in this case, for example, as the number of remaining NFTs of a certain type of content decreases, the attack power of the certain type of content may be changed to increase. Accordingly, even when the upper limit number is not provided, a change in the remaining number of NFTs corresponding to the same type of content (characteristics of the NFTs) is associated with the play of the game. Therefore, it is possible to improve the interest of the game using the NFT.

In the example of the above-described embodiment, there may be only one type of content, or there may be a plurality of types of content.

The issuing unit in the example of the above-described embodiment may be configured to issue the NFT to the blockchain network by performing the NFT issuance request as described above, or may be configured to issue the NFT by itself. In addition, a configuration in which the owner transfers (changes the owner) to the user the NFT corresponding to the issued content that is the manager of the game is also included in the issuance of the NFT by the issuance unit.

In the example of the above-described embodiment, the configuration in which the NFT is issued when the content in the game is purchased by the user has been described. The content may be obtained by the user, and may be, for example, content obtained (provided) to the user according to the result of playing the game.

The change condition of the example of the above-described embodiment includes only one condition, but may include a plurality of conditions. For example, the conditions A, B, and C may be changed. In this case, when any one of the conditions A, B, and C is satisfied, the change condition may be satisfied. Alternatively, when all of the conditions A, B, and C are satisfied, the change condition may be satisfied. The change condition may be periodically changed.

In addition, the change condition may be, for example, that the number of issued NFTs has reached the upper limit number.

The change of the status of the example of the above-described embodiment is not limited to the example described above. For example, as the number of remaining NFTs of a certain type of content increases, a specific parameter of the certain type of content may increase. Further, for example, when the ratio (remaining number/issued number) becomes equal to or larger than a predetermined value, a predetermined event may be newly added to an in-game event in which a certain type of content can be executed.

The number of times of execution of the status change in the example of the above-described embodiment may be limited so as not to change after the status change is once performed, even if the status change is repeatedly performed. In this case, the number of times the change is permitted (limited number of times) may be stored in the storage unit of the server device.

The status of the content of the above-described embodiment may be recorded in the blockchain as data of the NFT. For example, the status of the content may be included in the metadata of the blockchain of the NFT corresponding to the content. In this case, the server device (setting unit) may change the status included in the metadata. In this case, the status may be managed on metadata without storing the status in the storage unit of the server device.

In the example of the above-described embodiment, the operating entity of the server device and the operating entity of the blockchain network may be different or the same.

### Second Embodiment

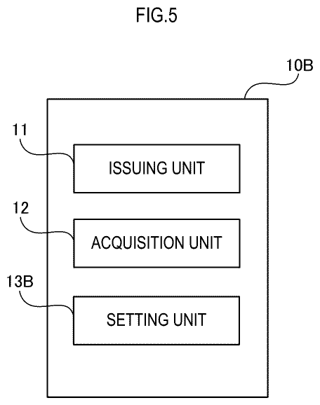

FIG. 5 is a block diagram illustrating a configuration of a server device 10B which is an example of the server device 10. In the example of the present embodiment, the server device 10B includes at least an issuing unit 11, an acquisition unit 12, and a setting unit 13B.

In the example of the present embodiment, the value of a specific parameter in the game status associated with the content is changed. Specifically, a distribution value obtained by dividing (equally dividing) a predetermined value according to the remaining number is added to a basic value of a specific parameter. The specific parameter is, for example, a parameter of attack power. The predetermined value may be stored in the storage unit of the server device 10B, for example.

For example, an NFT corresponding to a content in which the upper limit number of issuances is 1200 will be described. The predetermined value is 1200. When the NFT corresponding to the content is issued up to 1200 of the upper limit number and the remaining number is 1200, the distribution value is 1. That is, it is calculated as follows.

(predetermined value: 1200)/(remaining number: 1200)=(distribution value: 1).

Therefore, the specific parameter of the content is changed to {basic value (distribution value: 1)}. Thereafter, when the remaining number decreases to 300, the distribution value becomes 4. That is, it is calculated as follows.

(predetermined value: 1200)/(remaining number: 300)=(distribution value: 4).

Therefore, the specific parameter of the content is changed to {basic value (distribution value: 4)}.

As described above, the distribution value increases as the remaining number decreases. For example, when the specific parameter is the attack power, the smaller the remaining number, the more the attack power increases.

Further, in the example of the present embodiment, for example, when the change condition is satisfied, the above-described specific parameter is changed. For example, the change condition is that the number of issued NFTs corresponding to the same type of content has reached the upper limit number. Therefore, in the above-described example, the distribution value is not calculated unless the number of NFTs issued corresponding to the content reaches the upper limit number of 1200. Therefore, when the number of NFTs issued corresponding to the content is less than 1200, for example, the distribution value is set to an initial value of 0. In this case, the specific parameter is {basic value (distribution value: 0)}.

The issuing unit 11 issues the NFT corresponding to the content with the user as the owner within the range of the upper limit number. For example, the issuing unit 11 issues an NFT corresponding to the content to the blockchain network 30 by making an issuance request. For example, the issuing unit 11 receives a purchase request for the content (NFT) from the user (the terminal devices 20 and 201 to 20N). Thus, the issuing unit 11 performs payment processing (billing processing) with legal currency, virtual currency, or the like possessed by the user. After completion of the billing process, the issuing unit 11 transmits an NFT issuance request corresponding to the purchased content to the blockchain network 30.

For example, the issuing unit 11 transmits (uploads) information specifying the content of the game, information specifying the owner, and the like to the blockchain network 30 together with the NFT issuance request. As a result, the NFT corresponding to the content is issued in the blockchain network 30. Then, the issuing unit 11 sends the NFT corresponding to the content to the wallet (terminal device) of the purchaser (user).

In addition, the issuing unit 11 does not accept the issuance of the NFT of the content of which the issuance number has reached the upper limit number. The upper limit number is set for each type of content.

The information (including the upper limit number) relating to the content (NFT) to be sold may be stored in the storage unit of the server device 10B. When a plurality of types of contents (NFT) are sold, an image of a list of sales contents may be displayed on a terminal device of a user, and the user may select contents to be purchased.

The acquisition unit 12 acquires information for specifying the remaining number of NFTs corresponding to the same type of content in the blockchain network 30. The information for specifying the remaining number corresponds to, for example, the number of issuances and the number of burns with respect to the NFT corresponding to the same type of content. A value obtained by subtracting the number of burns from the number of issuances is the remaining number.

For example, the acquisition unit 12 may acquire the number of issuances and the number of burns from the storage unit of the server device 10B. In this case, for example, the issuance number may be updated by the issuing unit 11. Specifically, when receiving the information on the completion of the issuance of the NFT corresponding to the content from the blockchain network 30, the issuing unit 11 adds 1 to the number of issuances of the NFT corresponding to the content. That is, the issuing unit 11 updates the number of NFTs issued corresponding to the content for each of the same types.

Further, for example, the number of burns may be updated by the server device 10B functioning as a burn unit. The burner burns the designated NFT based on a request from the user. Specifically, when receiving the information of the burn completion of the NFT corresponding to the content from the blockchain network 30, the burn unit adds 1 to the number of burns of the NFT corresponding to the content. That is, the burn unit updates the number of burns of the NFT corresponding to the content for each of the same types.

The above-described example is effective when the issuance of the NFT and the burn are executed via the server device 10B. In addition, for example, the acquisition unit 12 may calculate the remaining number for each type after acquiring the number of issued NFTs and the number of burns corresponding to the content for each type.

The information for specifying the remaining number may be, for example, the remaining number itself. In this case, the acquisition unit 12 may request the blockchain network 30 to transmit the remaining number of NFTs corresponding to each type of content. Specifically, the acquisition unit 12 requests the blockchain network 30 to transmit the identification information of the game and the identification information of the content. As a result, the remaining number of NFTs corresponding to each type of content is transmitted from the blockchain network 30 to the server device 10B.

The setting unit 13B changes a part of the game status associated with the content according to the remaining number of NFTs of the content of the same type. In the example of the present embodiment, the setting unit 13B changes the value of a specific parameter among the game statuses associated with the content. As described above, the change is performed in which the distribution value obtained by dividing (equally dividing) the predetermined value according to the remaining number is added to the basic value of the specific parameter.

In addition, as described above, the setting unit 13B changes the above-described specific parameters for the NFT of the content satisfying the change condition. The change condition is that the number of issued NFTs corresponding to the same type of content has reached the upper limit number.

All the statuses for the game of the content may be stored in the storage unit of the server device 10B. Therefore, the setting unit 13B may change (update) the specific status stored in the storage unit of the server device 10B, for example.

The setting unit 13B may specify the remaining number by referring to the information on the remaining number acquired by the acquisition unit 12. When the acquisition unit 12 calculates the remaining number or when the acquisition unit 12 acquires the remaining number, the remaining number may be referred to. The setting unit 13B may acquire the upper limit number from the storage unit of the server device 10B.

In addition, the setting unit 13B may perform the change with reference to the change content including the change condition and the like. The content of the change may be stored in the storage unit of the server device 10B, for example. In addition, the change content may be common to all types of content, or may be different for each type of content. In the case where the change content is different for each type of content, the change content may be stored in association with the identification information of the content.

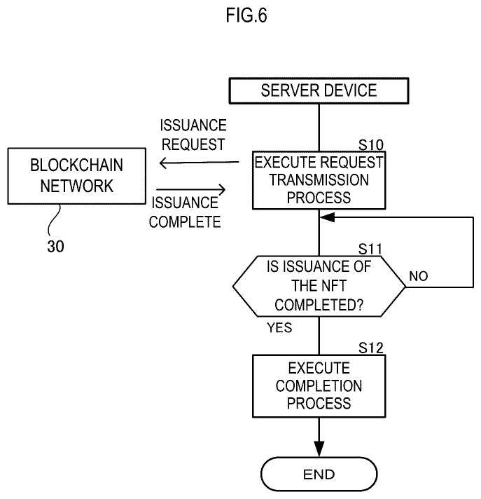

FIG. 6 is a flowchart illustrating an example of issuance processing executed by the system 100. The issuing process in the example of the present embodiment is a process for issuing an NFT corresponding to a content in the blockchain network 30. In FIG. 6, the process of issuing the NFT of the content purchased by the user is mainly described, and the other processes may be partially omitted. Hereinafter, a case where the NFT of the sticker purchased by the user (terminal device 20) is issued will be described as an example.

The issuing process of the example of the present embodiment is started, for example, when the payment process (billing process) of the content desired to be purchased selected by the user (terminal device 20) is completed. As described above, the billing process is executed when a purchase request for the selected content is received from the user (terminal device 20). The user may select the content desired to be purchased from the image of the list of the NFT-issuable content displayed on the terminal device 20.

The server device 10B executes a request transmission process (step S10). In the request transmission process, an NFT issuance request corresponding to the purchased content is transmitted from the server device 10B to the blockchain network 30. For example, the server device 10C transmits information for specifying the content of the game, information for specifying the owner, and the like to the blockchain network 30 together with the NFT issuance request.

Next, the server device 10B determines whether or not the issuance of the NFT is completed (step S11). The server device 10B waits until the issuance of the NFT is completed. When receiving the information indicating that the issuance of the NFT has been completed from the blockchain network 30, the server device 10B determines that the issuance of the NFT has been completed.

When the issuance of the NFT is completed (step S11: YES), the server device 10B executes a completion process (step S12). In the completion process, the server device 10B sends the NFT corresponding to the content to the wallet (terminal device 20) of the purchaser (user). In addition, the server device 10B may add 1 to the number of NFTs issued corresponding to the content, for example. The number of issuances may be stored in the storage unit of the server device 10B. Further, the server device 10B may transmit, for example, the completion of the issuance of the NFT to the user (the terminal device 20). After that, the server device 10B ends the issuance process.

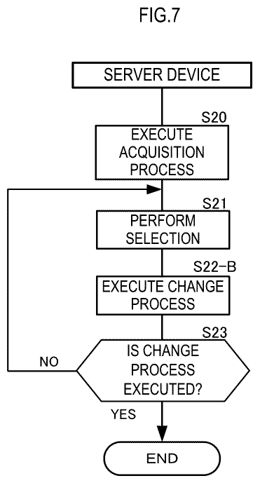

FIG. 7 is a flowchart illustrating an example of setting processing executed by the system 100. The setting processing in the example of the present embodiment is processing for changing at least a part of the status of the content. In FIG. 7, the process of acquiring the above-described information for specifying the remaining number and the process of changing at least a part of the status are mainly described, and other processes may be partially omitted.

The setting process of the example of the present embodiment is repeatedly executed, for example, every time a predetermined period elapses (for example, in units of one frame).

The server device 10B executes an acquisition process (step S20). In the acquisition process, the information for specifying the remaining number is acquired. For example, as information for specifying the remaining number, the number of issuances and the number of burns are acquired from the storage unit of the server device 10B. In the acquisition processing, for example, the number of issued NFTs and the number of burns corresponding to the content for each type are acquired, and the remaining number for each type is calculated. Instead of the acquisition process, a transmission request may be made to the blockchain network 30 to acquire the remaining number of NFTs of each type of content.

Next, the server device 10B selects an NFT corresponding to one type of content (step S21), and executes a change process (step S22-B). In the change process, a part of the status of the one type of content is changed. As in the example described above, when the number of NFTs issued corresponding to the one type of content reaches the upper limit number (the change condition is satisfied), the specific parameter of the one type of content is changed. Specifically, a distribution value obtained by dividing (equally dividing) a predetermined value according to the remaining number is added to the basic value of the specific parameter. When the change condition is not satisfied, the change of the status is not executed, and the change process is ended.

Next, the server device 10B determines whether or not the change processing has been executed for the NFTs corresponding to all types of contents (step S23). When the process is not executed (step S23: NO), the server device 10B returns to the process of step S21. Thereafter, an NFT corresponding to another type of content is selected, and the same processing as described above is executed. On the other hand, when the change processing is executed for the NFTs corresponding to all types of contents (step S23: YES), the server device 10B ends the setting processing.

As described above, as one aspect of the second embodiment, since the server device 10B is configured to include the issuing unit 11, the acquisition unit 12, and the setting unit 13B, a change in the number of remaining NFTs corresponding to the same type of content (characteristics of the NFTs) is associated with the play of the game. Accordingly, it is possible to improve the interest of the game using the NFT.

Note that the video game of the example of the above-described embodiment can adopt games of various genres as long as content such as characters is used.

Although a predetermined value is set as the upper limit number in the example of the above-described embodiment, the upper limit number is not particularly limited thereto. For example, the number of issuances when the NFT is issued with a limited period also corresponds to the upper limit number. Specifically, the NFT corresponding to a certain type of content is released (issued) unlimitedly only for one month of the sales period. After the sales period has elapsed, this NFT is not issued. In this case, the number of issued NFTs corresponding to a certain type of content during the sales period corresponds to the upper limit number.

In the example of the above-described embodiment, the upper limit number is provided for the issuance of the NFT, but the upper limit number may not be provided. Even in this case, for example, as the number of remaining NFTs of a certain type of content decreases, a specific parameter of the certain type of content may be changed to increase. Accordingly, even when the upper limit number is not provided, a change in the remaining number of NFTs corresponding to the same type of content (characteristics of the NFTs) is associated with the play of the game. Therefore, it is possible to improve the interest of the game using the NFT.

Although the change condition is provided in the example of the above-described embodiment, the change condition may not be provided.

In the example of the above-described embodiment, there may be only one type of content, or there may be a plurality of types of content.

As described above, the issuing unit in the example of the above-described embodiment may be configured to issue an NFT to the blockchain network by making an NFT issuance request, or may be configured to issue an NFT by itself. In addition, a configuration in which the owner transfers (changes the owner) to the user the NFT corresponding to the issued content that is the manager of the game is also included in the issuance of the NFT by the issuance unit.

In the example of the above-described embodiment, the configuration in which the NFT is issued when the content in the game is purchased by the user has been described. The content may be obtained by the user, and may be, for example, content obtained (provided) to the user according to the result of playing the game.

The change condition of the example of the above-described embodiment includes only one condition, but may include a plurality of conditions. For example, the conditions A, B, and C may be changed. In this case, when any one of the conditions A, B, and C is satisfied, the change condition may be satisfied. Alternatively, when all of the conditions A, B, and C are satisfied, the change condition may be satisfied. The change condition may be periodically changed.

In the example of the above-described embodiment, a part of the status is changed.

The number of times of execution of the status change in the example of the above-described embodiment may be limited so as not to change after the status change is once performed, even if the status change is repeatedly performed. In this case, the number of times the change is permitted (limited number of times) may be stored in the storage unit of the server device.

The status of the content of the above-described embodiment may be recorded in the blockchain as data of the NFT. For example, the status of the content may be included in the metadata of the blockchain of the NFT corresponding to the content. In this case, the server device (setting unit) may change the status included in the metadata. In this case, the status may be managed on metadata without storing the status in the storage unit of the server device.

In the example of the above-described embodiment, the operating entity of the server device and the operating entity of the blockchain network may be different from or the same as each other.

### Third Embodiment

FIGS. 8A and 8B are a schematic view each showing an example of an NFT sticker corresponding to at least one embodiment of the disclosure. In the example of the present embodiment, a battle game using a sticker-like virtual object including an image of a character in a game space (virtual space) is provided. Specifically, the character performs a battle. Hereinafter, the sticker-like virtual object is simply referred to as a sticker. The sticker corresponds to content used in the game.

In addition, in the example of the present embodiment, it is possible to use two types of NFT stickers SS1 and SS2 for battle in the game. The NFT stickers SS1 and SS2 are stickers to which the NFT is issued. The NFT stickers SS1 and SS2 have the same configuration as a sticker in which no NFT is issued in the game. The NFT stickers SS1 and SS2 correspond to contents used in the game.

As shown in FIGS. 8A and 8B, token IDs are associated with the NFT stickers SS1 and SS2, and metadata, transaction history, and the like are associated with the token IDs. The metadata includes a game ID, a sticker ID, a status, information (not shown) for specifying the owner, and the like. The game ID is identification information of the game, and the sticker ID is identification information of the content. The status is a status for a game of a sticker (character) corresponding to the sticker ID, and is data referred to in the progress (battle) of the game. For example, parameters (numerical values) such as vitality (HP), attack power (ATK), and defense power (DEF) are included in the status. In addition, for example, an in-game event (an attack such as a magic) that can be executed is also included in the status.

In the game, the NFT corresponding to the sticker is issued with the purchased user as the owner. For the purchase, for example, in-game currency is used. The in-game currency may be purchased by consuming legal currency, for example. While the user is playing a game on his or her terminal device, the user can purchase the game by a purchase operation. In addition, in the game, the NFT corresponding to the sticker can be burned in response to a request from the user (owner). Further, the NFT is also capable of trading (secondary distribution) in the NFT marketplace (blockchain network 30).

In the example of the present embodiment, the issuance and the burn of the NFT corresponding to the sticker are executed only via the system 100 (server device 10C).

In the example of the present embodiment, a part of the status of the sticker is changed according to the remaining number of NFTs corresponding to the same type of sticker. Hereinafter, two types of NFT stickers SS1 and SS2 will be described as an example. In each of the NFT stickers SS1 and SS2, the upper limit number of NFT issuances is 1200.

The remaining number of NFTs corresponding to the same type of sticker is the current number of NFTs effectively present in the blockchain network 30. The remaining number of NFTs corresponding to the same type of content is counted by an NFT issued with the user as an owner. That is, the remaining number of NFTs corresponding to the same type of content is the remaining number of NFTs after primary distribution.

Regarding the NFT sticker SS1, the attack power included in the status is changed according to the remaining number. Specifically, the predetermined value: a distribution value obtained by dividing 1200 (a mountain dividing point) according to the remaining number is added to the basic value of the attack power. The predetermined value may be stored in the storage unit of the server device 10C, for example.

When the NFT sticker SS1 (NFT) is issued up to 1200 of the upper limit number and the remaining number is 1200, the distribution number is 1. That is, it is calculated as follows.

(predetermined value: 1200)/(remaining number: 1200)=distribution value: 1

Therefore, the attack power of the NFT sticker SS1 is changed to {basic value (distribution value: 1)}. Thereafter, when the remaining number decreases to 300, the distribution value becomes 4. That is, it is calculated as follows.

(predetermined value: 1200)/(remaining number: 300)=distribution value: 4

Therefore, the attack power of the NFT sticker SS1 is changed to {basic value (distribution value: 4)}.

As described above, the distribution value increases as the remaining number decreases. Therefore, the smaller the remaining number is, the more the attack power is increased and the more the attack power is enhanced.

Further, regarding the NFT sticker SS1, when the change condition is satisfied, the above-described change of the attack power is performed. Specifically, the change condition is that the number of issued NFTs corresponding to the same type of content has reached the upper limit number. Therefore, when the number of issuances is less than 1200, for example, the distribution value is set to 0 as an initial value. In this case, the attack power is {basic value (distribution value: 0)}.

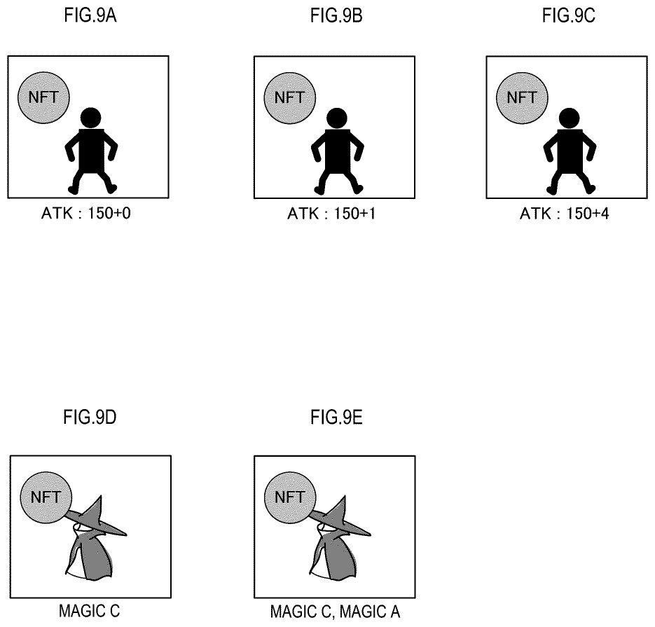

Therefore, when the change condition is not satisfied for the NFT sticker SS1, the attack power becomes {(basic value: 150) (distribution value: 0)} as shown in FIG. 9A. Thereafter, when the change condition is satisfied, the remaining number: in the case of 1200, as shown in FIG. 9B, the attack power is changed to {(basic value: 150) (distribution value: 1)}. Further, when the change condition is satisfied, the remaining number: in the case of 300, as shown in FIG. 9C, the attack power is changed to {(basic value: 150) (distribution value: 4)}.

Note that a distribution value obtained by equally distributing the predetermined value by the remaining number may not be applied. For example, the distribution value may be associated with the range of the remaining number such that 1 is set as the distribution value when the remaining number is 1200 or less, and 3 is set as the distribution value when the remaining number is 600 or less.

Next, regarding the NFT sticker SS2, a predetermined event is newly added to the executable in-game event included in the status according to the remaining number. Specifically, when the change condition is satisfied, a predetermined event is newly added to the executable in-game event. In the change condition, a ratio (remaining number/issuing number) of the remaining number is a predetermined value: that is, it is 0.5 or less. That is, with respect to the NFT sticker SS2, when the remaining number is equal to or less than half of the number of issuances, a predetermined event is added. The predetermined value may be stored in the storage unit of the server device 10C, for example.

The predetermined event is an event that causes the character of the NFT sticker SS2 to attack the magic A. That is, a special ability is newly added to the character of the NFT sticker SS2. In the NFT sticker SS2, magic C is set as an in-game event that can be executed. Therefore, when the change condition is satisfied, the NFT sticker SS2 can execute the magic A in addition to the magic C. As a result, the user can more advantageously proceed with the game.

Therefore, with respect to the NFT sticker SS2, when the change condition is not established, as shown in FIG. 9D, only the magic C is the in-game event that can be executed. Thereafter, when the change condition is satisfied, as shown in FIG. 9E, the in-game events that can be executed are changed to magic C and magic A.

Note that the change condition for the NFT sticker SS2 is after the number of NFTs issued corresponding to the same type of content reaches the upper limit number, and the ratio (remaining number/number of issued) is a predetermined value: it may be 0.5 or less.

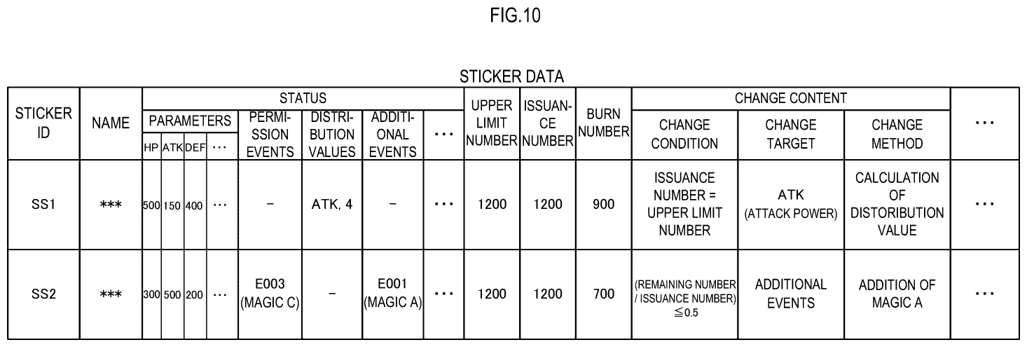

The data relating to each sticker is stored in the storage unit of the server device 10C. FIG. 10 shows an example of sticker data related to the NFT stickers SS1 and SS2. In the progress of the game, sticker data is referred to.

The sticker data includes fields such as a sticker ID, a name, a status, an upper limit number, an issuance number, a burn number, and a change content. In the sticker ID field, sticker identification information is set. In the name field, text data of the name of the sticker (sticker ID) is set.

The status field is the status of the sticker (sticker ID). More specifically, it is a status related to a character included in the sticker. The status field is composed of fields such as parameters, permission events, distribution values, and additional events. The field of the parameters includes fields of vital power (HP), attack power (ATK), defense power (DEF), and the like. A basic value is set in the field of each parameter. In the field of the permission events, an in-game event in which a sticker (sticker ID) can be executed is set. More specifically, an in-game event that can be executed by a character included in the sticker is set. For example, event identification information (event ID) is set. When there is no executable event, a value of no event is set.

In the field of the distribution values, the data specifying the addition target and the distribution value calculated according to the remaining number are set. In the case of the NFT sticker SS1 (sticker ID: SS1), (ATK, 4) is set in FIG. 10. That is, in FIG. 10, the attack power of the NFT sticker SS1=(basic value: 150) (distribution value: 4). When the distribution value is not calculated as in the NFT sticker SS2 (sticker ID: SS2), a value without the distribution value is set. In addition, only the basic value is used for the parameters such as the vital power to which the distribution value is not added. For example, in the case of the NFT sticker SS1 (sticker ID: SS1), in FIG. 10, the vitality-(basic value: 500).

In the field of the additional events, an executable in-game event to be newly added according to the remaining number is set. For example, an event ID is set. In the case of the NFT sticker SS2 (sticker ID: SS2), in FIG. 10, the magic A (event ID: E001) is set in the field of the additional event. That is, in the case of the NFT sticker SS2 (sticker ID: SS2), in FIG. 10, magic A (event ID: E001) is added as an executable in-game event in addition to magic C (event ID: E001). When an event is not added as in the NFT sticker SS1 (sticker ID: SS1), a value without addition is set.

In the field of the upper limit number, the upper limit number of NFT issuances of the sticker (sticker ID) is set. In the field of the issuance number, the number of NFTs issued of the current sticker (sticker ID) is set. In the field of the burn number, the number of burns of the NFT of the current sticker (sticker ID) is set.

Various kinds of data for changing a part of the status of the sticker (sticker ID) are set in the change content field. The field of the change content includes fields of a change condition, a change target, a change method, and the like. In the field of the change condition, a condition for changing a part of the status of the sticker (sticker ID) is set. When the change condition is not set, a value for specifying no setting is set. In the field of the change target, data specifying a status to be changed is set. In the field of the change method, data specifying a change method is set.

Although not shown, the data of the sticker that is not the target of the NFT issuance is also stored in the storage unit of the server device 10C. The status of the metadata of the NFT is periodically updated so as to be synchronized with the status of the sticker data.

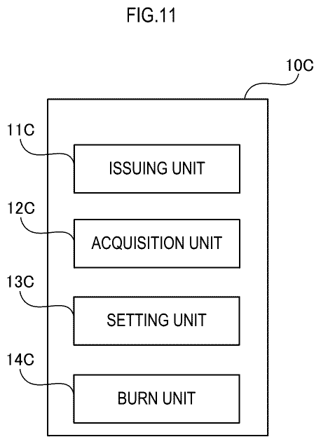

FIG. 11 is a block diagram illustrating a configuration of a server device 10C which is an example of the server device 10. In the example of the present embodiment, the server device 10C includes at least an issuing unit 11C, an acquisition unit 12C, a setting unit 13C, and a burn unit 14C.

The issuing unit 11C issues the NFT corresponding to the content with the user (purchaser) as the owner within the range of the upper limit number. The issuing unit 11C also has a sales function. For example, the issuing unit 11C refers to the sticker data or the like, and causes the terminal device of the user who desires to purchase to display an image of a list of stickers that can be sold. The user may select a desired sticker by operating his/her terminal device.

When a purchase request for the selected sticker is received from the user (terminal device), the issuing unit 11C performs payment processing (billing processing) with the in-game currency possessed by the user. After the charging process is completed, the issuing unit 11C transmits an NFT issuance request corresponding to the purchased sticker to the blockchain network 30. The issuing unit 11C transmits (uploads) information specifying the content of the game, information specifying the status and the owner, and the like to the blockchain network 30 together with the NFT issuance request. As a result, the NFT corresponding to the sticker is issued in the blockchain network 30. The issuing unit 11C transmits the NFT corresponding to the sticker to the wallet (terminal device) of the purchaser (user) when receiving the information of the completion of the issuance of the NFT corresponding to the content (sticker) from the blockchain network 30.

In addition, the issuing unit 11C does not accept the issuance of the NFT of the sticker whose issuance number has reached the upper limit number. As the upper limit number, the upper limit number of sticker data may be referred to.

The information specifying the content of the game includes, for example, the identification information (game ID) of the game and the identification information (sticker ID) of the sticker in the example of the present embodiment.

The information specifying the owner is identification information (user ID) of the user who purchases (obtains) the content. The user ID is, for example, a wallet address of the user (terminal device). The user ID is also stored in the server device 10C while being included in the user data of the user.

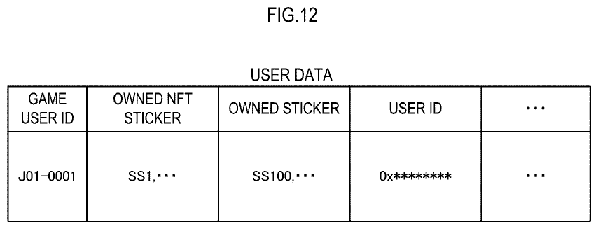

The user data is data related to the game of the user, and is stored in the storage unit of the server device 10C for each user. FIG. 12 is a diagram illustrating an example of user data of one user. The user data includes fields such as a game user ID, an owned NFT sticker, an owned sticker, and a user ID.

In the field of the game user ID, identification information of a game user is set. In the field of the owned NFT sticker, identification information (sticker ID) of the NFT sticker stored in the wallet of the user is set. That is, the identification information of the NFT sticker owned by the user is set. The user can use the NFT sticker set in the field of the owned NFT sticker in the game. In this case, based on the sticker ID of the owned NFT sticker, the name, status, and the like of the owned NFT sticker are referred to from the sticker data. Therefore, when the status has already been changed in the sticker data, the change is reflected.

Next, identification information (sticker ID) of the sticker owned by the user is set in the field of the owned sticker. Note that identification information of a sticker for which an NFT is not issued is set in the possessed sticker field. Further, the user can use the sticker set in the field of the owned sticker in the game.

In the field of the user ID, the identification information (user ID) of the user described above is set. That is, the information specifying the owner of the NFT is set in the field of the user ID. In the user ID field, the wallet address of the user (terminal device) is set.

Further, when receiving the information on the completion of the issuance of the NFT corresponding to the content (sticker) from the blockchain network 30, the issuing unit 11C adds 1 to the number of NFTs issued corresponding to the sticker (sticker ID). That is, the issuing unit 11C updates the “number of issuances” of the sticker data for each type.

The acquisition unit 12C acquires information for specifying the remaining number of NFTs corresponding to the same type of content (sticker) in the blockchain network 30. The information for specifying the remaining number corresponds to the number of issuances (and the number of burns) with respect to the NFT corresponding to the same type of content. a value obtained by subtracting the number of burns from the number of issuances is the remaining number.

The acquisition unit 12C refers to the storage unit (sticker data) of the server device 10C and acquires the number of issuances and the number of burns of each type. After acquiring the number of issued NFTs and the number of burns corresponding to the content for each type, the acquisition unit 12 calculates the remaining number for each type.

The setting unit 13C changes a part of the game status associated with the sticker according to the remaining number of NFTs of the same type of content (stall). In the example of the present embodiment, the setting unit 13C changes the attack power with respect to the NFT sticker SS1. As described above, when the change condition is satisfied, the distribution value obtained by dividing (equally dividing) the predetermined value according to the remaining number is added to the basic value of the attack power. Specifically, the setting unit 13C updates the “distribution values” of the sticker data.

The setting unit 13C changes the executable in-game event with respect to the NFT sticker SS2. As described above, when the change condition is satisfied, a predetermined event (magic A) is added as an in-game event that can be executed. Specifically, the setting unit 13C updates the “addition events” of the sticker data.

The setting unit 13C may refer to the information on the remaining number acquired by the acquisition unit 12C. The setting unit 13C may refer to each data of the sticker data of the server device 10C.

The setting unit 13C also updates the status of the metadata of the NFT so as to be synchronized with the status of the sticker data.

The burn unit (burn function, burn means, burn processing) 14C burns the selected NFT based on a request from the user. For example, by referring to the above-described user data or the like, an image of a list of owned NFT stickers is displayed on the terminal device of the user who has made the burn candidate display request. The user may select a desired NFT by operating his/her terminal device.

When receiving the burn request of the selected NFT from the user (terminal device), the burn unit 14C transmits the burn request of the selected NFT to the blockchain network 30. The burn unit 14C transmits the token ID of the selected NFT to the blockchain network 30 together with the burn request of the NFT. As a result, the selected NFT is burned in the blockchain network 30. Then, the burn unit 14C deletes the data related to the selected NFT from the wallet (terminal device) of the user.

Further, when receiving the information of the burn completion of the NFT corresponding to the content (sticker) from the block chain network 30, the burn unit 14C adds 1 to the number of burns of the NFT corresponding to the sticker (sticker ID). That is, the burn unit 14C updates the “number of burns” of the sticker data for each type.

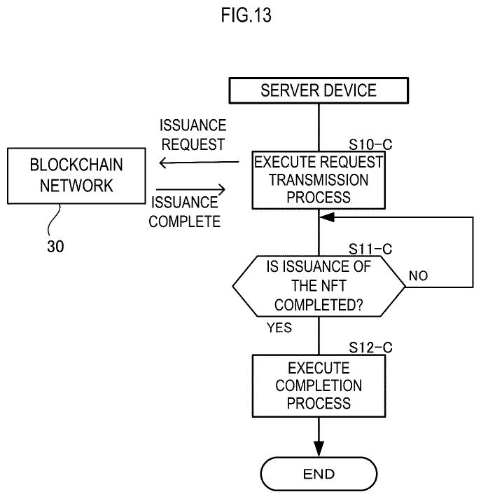

FIG. 13 is a flowchart illustrating an example of issuance processing executed by the system 100. The issuing process of the example of the present embodiment is a process for issuing an NFT corresponding to a content (sticker) in the blockchain network 30. In FIG. 13, the process of issuing the NFT of the sticker purchased by the user is mainly described, and the other processes may be partially omitted. Hereinafter, a case where the NFT of the sticker purchased by the user (terminal device 20) is issued will be described as an example. The issuing process of the example of the present embodiment is started, for example, when the payment process (billing process) of the sticker desired to be purchased selected by the user (terminal device 20) is completed. As described above, the billing process is executed when a purchase request for the selected sticker is received from the user (terminal device). The user may select the sticker desired to be purchased from the image of the list of stickers capable of issuing the NFT displayed on the terminal device 20.

The server device 10C executes a request transmission process (step S10-C). In the request transmission process, an NFT issuance request corresponding to the purchased sticker is transmitted from the server device 10C to the blockchain network 30. More specifically, the server device 10C transmits, together with the NFT issuance request, information specifying the content (sticker) of the game, information specifying the status and the owner, and the like to the blockchain network 30.

Next, the server device 10C determines whether or not the issuance of the NFT is completed (step S11-C). The server device 10C waits until the issuance of the NFT is completed. When receiving the information indicating that the issuance of the NFT has been completed from the blockchain network 30, the server device 10C determines that the issuance of the NFT has been completed.

When the issuance of the NFT is completed (step S11-C: YES), the server device 10C executes a completion process (step S12-C). In the completion process, the server device 10C sends the NFT corresponding to the sticker to the wallet (terminal device 20) of the purchaser (user). In addition, the server device 10C adds 1 to the number of NFTs issued corresponding to the sticker. That is, the server device 10C updates the “number of issuances” of the sticker (sticker ID) in the sticker data. Further, although not illustrated, the server device 10C transmits the completion of the issuance of the NFT to the user (the terminal device 20). After that, the server device 10C ends the issuance process.

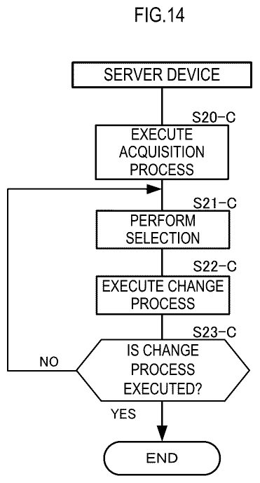

Next, FIG. 14 is a flowchart illustrating an example of setting processing executed by the system 100. The setting processing in the example of the present embodiment is processing for changing a part of the status of the content (sticker). In FIG. 14, a process of acquiring the above-described information for specifying the remaining number and a process of changing a part of the status are mainly described, and other processes may be partially omitted.

The setting process of the example of the present embodiment is repeatedly executed, for example, every time a predetermined period elapses (for example, in units of one frame).

The server device 10C executes an acquisition process (step S20-C). In the acquisition process, the information for specifying the remaining number is acquired. For example, as information for specifying the remaining number, the number of issuances and the number of burns are acquired from the storage unit of the server device 10C. That is, the number of issued NFTs and the number of burns corresponding to stickers of each type (sticker ID) are acquired with reference to the sticker data, and the remaining number of stickers of each type is calculated. In the example of the present embodiment, the number of NFTs issued and the number of burns of two types of NFT stickers SS1 and SS2 (sticker IDs: SS1 and SS2) are acquired.

Next, the server device 10C selects an NFT corresponding to one type of sticker (step S21-C), and executes a change process (step S22-C). In the change process, a part of the status of the one type of sticker is changed.

For example, a case where the NFT sticker SS1 (sticker ID: SS1) is selected will be described. When the change condition of the NFT sticker SS1 (sticker ID: SS1) is satisfied, the attack force is changed. Specifically, the “distribution value” of the sticker data of the NFT sticker SS1 (sticker ID: SS1) is updated. As described above, the distribution value is calculated by dividing the predetermined value according to the remaining number. When the change condition is not satisfied, the change of the status is not executed, and the change process is ended. The initial value of the distribution value may be set to 0.

In the change process, the server device 10C also transmits a request to the blockchain network 30 for the status included in the metadata of the NFT, and updates the status in the same manner as the status of the sticker data.

Next, the server device 10C determines whether or not the change processing has been executed for the NFTs corresponding to all types of contents (stickers) (step S23-C). When the process is not executed (step S23-C: NO), the server device 10C returns to the process of step S21-C. Thereafter, an NFT corresponding to another type of sticker is selected, and the same processing as described above is executed. For example, an unexecuted NFT sticker SS2 (sticker ID: SS2) is selected. Then, a change process is executed on the NFT sticker SS2 (sticker ID: SS2).

On the other hand, when the change processing is executed for the NFTs corresponding to all types of contents (stickers) (step S23-C: YES), the server device 10C ends the setting processing.

In the change process of step S21-C, the NFT sticker SS2 (sticker ID: SS2) may not be changed after the change condition is satisfied and a predetermined event (magic A) is added.

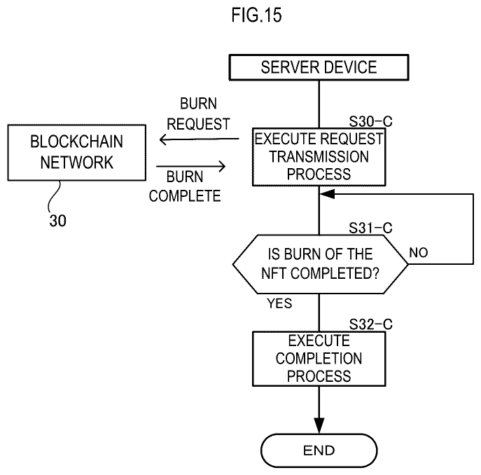

FIG. 15 is a flowchart illustrating an example of a burn process executed by the system 100. The burn process in the example of the present embodiment is a process for burning an NFT corresponding to a content (sticker) in the blockchain network 30. In FIG. 15, the process of burning the NFT of the sticker selected by the user is mainly described, and the other processes may be partially omitted. Hereinafter, a case where the NFT of the sticker selected by the user (terminal device 20) is burned will be described as an example.

The issuance process of the example of the present embodiment is started, for example, when the server device 10C receives a burn request from the user (terminal device 20). The user selects a burn-desired sticker from the image of the list of owned NFT stickers displayed on the terminal device 20. The terminal device 20 transmits the burn request together with the token ID of the selected NFT to the server device 10C.

The server device 10C executes a request transmission process (step S30-C). In the request transmission process, a burn request of the NFT corresponding to the selected sticker is transmitted from the server device 10C to the blockchain network 30. More specifically, the server device 10C transmits the token ID of the NFT to the blockchain network 30 together with the burn request of the NFT.

Next, the server device 10C determines whether or not the burn of the NFT is completed (step S31-C). The server device 10C waits until the burn of the NFT is completed. When receiving the information indicating that the burn of the NFT has been completed from the blockchain network 30, the server device 10C determines that the burn of the NFT has been completed.

When the burn of the NFT is completed (step S31-C: YES), the server device 10C executes a completion process (step S32-C). In the completion process, the server device 10C deletes the data related to the NFT corresponding to the sticker from the wallet (terminal device 20) of the user. In addition, the server device 10C adds 1 to the number of burns of the NFT corresponding to the sticker. That is, the server device 10C updates the “number of burns” of the sticker (sticker ID) in the sticker data. Further, although not illustrated, the server device 10C transmits the burn completion of the NFT to the user (the terminal device 20). Thereafter, the server device 10C ends the burn process.

As described above, as one aspect of the third embodiment, since the server device 10C is configured to include the issuing unit 11C, the acquisition unit 12C, the setting unit 13C, and the burn unit 14C, a change in the number of remaining NFTs (characteristics of NFTs) corresponding to the same type of content is associated with the play of the game. Accordingly, it is possible to improve the interest of the game using the NFT.

Note that the video game of the example of the above-described embodiment can adopt games of various genres as long as content such as characters is used.

Although a predetermined value is set as the upper limit number in the example of the above-described embodiment, the upper limit number is not particularly limited thereto. For example, the number of issuances when the NFT is issued with a limited period also corresponds to the upper limit number. Specifically, the NFT corresponding to a certain type of content is released (issued) unlimitedly only for one month of the sales period. After the sales period has elapsed, this NFT is not issued. In this case, the number of issued NFTs corresponding to a certain type of content during the sales period corresponds to the upper limit number.

In the example of the above-described embodiment, the upper limit number is provided for the issuance of the NFT, but the upper limit number may not be provided. Even in this case, for example, as the number of remaining NFTs of a certain type of content decreases, the attack power of the certain type of content may be changed to increase. Accordingly, even when the upper limit number is not provided, a change in the remaining number of NFTs corresponding to the same type of content (characteristics of the NFTs) is associated with the play of the game. Therefore, it is possible to improve the interest of the game using the NFT.

Although the change condition is provided in the example of the above-described embodiment, the change condition may not be provided.

In the example of the above-described embodiment, there may be only one kind of content, or there may be three or more kinds of content.

As described above, the issuing unit in the example of the above-described embodiment may be configured to issue an NFT to the blockchain network by making an NFT issuance request, or may be configured to issue an NFT by itself. In addition, a configuration in which the owner transfers (changes the owner) to the user the NFT corresponding to the issued content that is the manager of the game is also included in the issuance of the NFT by the issuance unit.

In the example of the above-described embodiment, the configuration in which the NFT is issued when the content in the game is purchased by the user has been described. The content may be obtained by the user, and may be, for example, content obtained (provided) to the user according to the result of playing the game.

In the example of the above-described embodiment, the issuance number and the burn number updated by the issuance unit and the burn unit are acquired as information for specifying the remaining number, but the disclosure is not particularly limited thereto. Information for specifying the remaining number may be acquired from the blockchain network.

For example, the server device (acquisition unit) requests the blockchain network to transmit the remaining number of NFTs corresponding to each type of content. Specifically, the server device requests the blockchain network to transmit the remaining number of contents by specifying the identification information of the game and the identification information of the contents. As a result, the remaining number of NFTs corresponding to each type of content is transmitted from the blockchain network to the server device. In this case, instead of the acquisition process of step S20-C in FIG. 14, the process of requesting the remaining number of transmissions to the blockchain network may be performed.

In the example of the above-described embodiment, the statuses of the NFTs corresponding to all types of contents may not be changed. Only NFTs corresponding to some types of contents may be changed in status. For a content of a type that is not a change target, for example, a value without a change setting may be set as the change content of the sticker data. As a result, the change process in FIG. 14 is not executed. Further, for example, information (change target information) for specifying the change target may be included in the metadata of the NFT corresponding to the content serving as the type of the change target. In this case, with respect to the NFT including the change target information, the server device may make a transmission request of the remaining number to the blockchain network.

The modification of the example of the above-described embodiment may be common to all types of content.

The change condition of the example of the above-described embodiment includes only one condition, but may include a plurality of conditions. For example, the conditions A, B, and C may be changed. In this case, when any one of the conditions A, B, and C is satisfied, the change condition may be satisfied. Alternatively, when all of the conditions A, B, and C are satisfied, the change condition may be satisfied. The change condition may be periodically changed.

The change of the status in the example of the above-described embodiment is not limited to the above-described configuration. For example, as the number of remaining NFTs of a certain type of content increases, a specific parameter (attack power) of the certain type of content may increase. Further, for example, when the ratio (remaining number/issued number) becomes equal to or larger than a predetermined value, a predetermined event (magic) may be newly added to an in-game event in which a certain type of content can be executed.

In the example of the above-described embodiment, a part of the status is changed.

The number of times of execution of the status change in the example of the above-described embodiment may be limited so as not to change after the status change is once performed, even if the status change is repeatedly performed. In this case, the number of times the change is permitted (limited number of times) may be stored in the storage unit of the server device.

The status of the content of the above-described embodiment may be recorded in the blockchain as only NFT data without being stored in the server device. For example, the status is recorded only in the metadata of the blockchain of the NFT corresponding to the content (sticker). In this case, the server device (setting unit) may change the status included in the metadata. Alternatively, the status may be stored only in the storage unit of the server device.

The burn section of the example of the above-described embodiment may correspond to a request other than a burn request from a user. For example, a process of synthesizing the character A and the NFT character B and evolving the character A will be described. When the fusion is executed, the NFT character B disappears. Therefore, with respect to the NFT of the character that disappears in the fusion, the burn unit may make a burn request to the blockchain network.

In the example of the above-described embodiment, the server device may not accept the burn of the NFT. For example, it may be accepted by marketplace or the like on the blockchain.

In the example of the above-described embodiment, the operating entity of the server device and the operating entity of the blockchain network may be different or the same.

### Appendixes

Based on the above descriptions, a person having ordinary skill in the art can practice at least the following example embodiments.

[1]

A video game processing program for causing a computer to realize a function of controlling progress of a video game including content used in the video game,
the video game processing program, when executed, causing the computer to realize:
an issuing function for issuing a non-fungible token (hereinafter, referred to as NFT) corresponding to the content in a blockchain network with the user as an owner within a range of the upper limit number,
an acquisition function for acquiring information for identifying the remaining number of NFTs corresponding to the same type of content in the blockchain network,
a setting function for changing at least a part of a game status associated with the content according to the remaining number.
   [2]

The video game processing program described in [1], in which
in the setting function, the distribution value obtained by dividing the predetermined value according to the remaining number is added to the basic value of the specific parameter included in the status, and
the distribution value increases as the remaining number decreases.
   [3]

The video game processing program described in [1], in which
in the issuing function, the number of NFTs issued corresponding to each content of the same type is stored in a storage unit,
in the setting function, at least a part of the status is changed when a ratio of the remaining number to the issuance number is equal to or less than a predetermined value.
   [4]

The video game processing program described in any one of [1] to [3], in which
in the setting function, a predetermined event is added as an executable in-game event included in the status according to the remaining number.
   [5]

The video game processing program described in any one of [1] to [4], in which the content is a sticker-like virtual object including a character.

[6]

The video game processing program described in any one of [1] to [5], further causing the computer to realize:
a burn function for burning a designated NFT based on a request from the user.
   [7]

The video game processing program described in any one of [1] to [6], in which
the content is a plurality of types of content, and
in the acquisition function, information for specifying the remaining number of NFTs corresponding to the status changeable content among the NFTs corresponding to the content is acquired.
   [8]

A server device in which the video game processing program according to any one of [1] to [7] is installed.

[9]

A video game processing program for causing a server device connected to a game terminal device that executes a video game including content used in the video game via a communication network, to control progress of the video game,
the video game processing program, when executed, causing the server device to realize:
an issuing function for issuing a non-fungible token (hereinafter, referred to as NFT) corresponding to the content in a blockchain network with the user as an owner within a range of the upper limit number,
an acquisition function for acquiring information for identifying the remaining number of NFTs corresponding to the same type of content in the blockchain network,
a setting function for changing at least a part of a status associated with the content according to the remaining number.
   [10]

The video game processing program described in [9], in which
in the setting function, the distribution value obtained by dividing the predetermined value according to the remaining number is added to the basic value of the specific parameter included in the status, and
the distribution value increases as the remaining number decreases.
   [11]

The video game processing program described in [9], in which
in the issuing function, the number of NFTs issued corresponding to each content of the same type is stored in a storage unit,
in the setting function, at least a part of the status is changed when a ratio of the remaining number to the issuance number is equal to or less than a predetermined value.
   [12]

The video game processing program described in any one of [9] to [11], in which
in the setting function, a predetermined event is added as an executable in-game event included in the status according to the remaining number.
   [13]

The video game processing program described in any one of [9] to [12], in which
the content is a sticker-like virtual object including a character.
   [14]

The video game processing program described in any one of [9] to [13], further causing the computer to realize:
a burn function for burning a designated NFT based on a request from the user.
   [15]

The video game processing program described in any one of [9] to [14], in which
the content is a plurality of types of content, and
in the obtaining function, information for specifying the remaining number of NFTs corresponding to the status changeable content among the NFTs corresponding to the content is acquired.
   [16]

A game system comprising:
a game terminal device that executes a video game including content used in a game; and
a server device that is connected to the terminal device via a communication network and controls progress of the video game, wherein
the game system includes
   an issuer for issuing a non-fungible token (hereinafter referred to as NFT) corresponding to the content in a blockchain network with the user as an owner within a range of the upper limit number,
   an acquirer for acquiring information for specifying the remaining number of NFTs corresponding to the same type of content in the blockchain network, and
   an setter for changing at least a part of a status associated with the content according to the remaining number.
      [17]

The game system described in [16], in which
the setter adds a distribution value obtained by dividing a predetermined value according to the remaining number to a basic value of a specific parameter included in the status, and
the distribution value increases as the remaining number decreases.
   [18]

The game system described in [16], in which
the issuer stores the number of NFTs issued corresponding to each content of the same type in a storage unit,
the setter changes at least a part of the status when a ratio of the remaining number to the issuance number is equal to or less than a predetermined value.
   [19]

The game system described in any one of [16] to [18], in which
the setter adds a predetermined event as an executable in-game event included in the status according to the remaining number.
   [20]

The game system described in any one of [16] to [19], in which
the content is a sticker-like virtual object including a character.
   [21]

The game system described in any one of [16] to [20], further comprising:
a burner for burning a designated NFT based on a request from the user.
   [22]

The game system described in any one of [16] to [21], in which
the content is a plurality of types of content, and
the acquirer acquires information for specifying the remaining number of NFTs corresponding to the status changeable content among the NFTs corresponding to the content.
   [22]

A video game processing method that is a game progress control method for causing a computer to control progress of a video game including content used in the video game, the video game processing method including:
an issuing process of issuing a non-fungible token (hereinafter, referred to as NFT) corresponding to the content in the blockchain network with the user as an owner within the range of the upper limit number,
an acquisition process of acquiring information for identifying the remaining number of NFTs corresponding to the same type of content in the blockchain network; and
a setting process of changing at least a part of a status associated with the content according to the remaining number.

According to one or more embodiments of the disclosure, it is useful to improve the interest of a game using an NFT.

What is claimed is:

1. A game system, comprising:
a terminal device configured to execute a video game including content used in the video game;
a server device connected to the terminal device via a communication network and configured to control progress of the video game; and
a processor configured to:
issue a non-fungible token (NFT) corresponding to the content in a blockchain network with a user as an owner within a range of an upper limit number;
acquire information for specifying a remaining number of NFTs corresponding to the same type of content in the blockchain network; and
change at least a part of a status associated with the content according to the remaining number.

2. The game system according to claim 1, wherein
the processor is further configured to:
obtain a distribution value by dividing a predetermined value according to the remaining number; and
add the distribution value to a basic value of a specific parameter included in the status, and
the distribution value increases as the remaining number decreases.

3. The game system according to claim 1, wherein the processor is further configured to:
store a number of NFTs issued corresponding to each content of the same type in a storage unit; and
change at least a part of the status if a ratio of the remaining number to the issuance number is equal to or less than a predetermined value.

4. The game system according to claim 1, wherein the processor is further configured to add a predetermined event as an executable in-game event included in the status according to the remaining number.

5. The game system according to claim 1, wherein the content is a sticker-like virtual object including a character.

6. The game system according to claim 1, wherein the processor is further configured to burn a designated NFT based on a request from the user.

7. The game system according to claim 1, wherein
the content is a plurality of types of content, and
the processor acquires information for specifying the remaining number of NFTs corresponding to status-changeable content among the NFTs corresponding to the content.

8. A non-transitory computer-readable medium including a video game processing program that, when executed, causes a computer that is configured to control progress of a video game including content used in the video game, to execute:
issue a non-fungible token (NFT) corresponding to the content in a blockchain network with a user as an owner within a range of an upper limit number;
acquire information for identifying a remaining number of NFTs corresponding to the same type of content in the blockchain network; and
change at least a part of a game status associated with the content according to the remaining number.

9. A non-transitory computer-readable medium including a video game processing program that, when executed, causes a server device that is connected to a terminal device via a communication network and configured to control progress of a video game, the terminal device configured to execute the video game including content used in the video game, to execute:
issue a non-fungible token (NFT) corresponding to the content in a blockchain network with a user as an owner within a range of an upper limit number;
acquire information for identifying a remaining number of NFTs corresponding to the same type of content in the blockchain network; and
change at least a part of a status associated with the content according to the remaining number.
